(19) United States
(12) Patent Application Publication
(10) Pub. No.: US 2024/0312196 A1
(43) Pub. Date: Sep. 19, 2024

(54) APPARATUS AND METHOD FOR DYNAMIC QUADRUPLE CONVOLUTION IN 3D CNN

(71) Applicant: Intel Corporation, Santa Clara, CA (US)

(72) Inventors: Dongqi CAI, Beijing (CN); Anbang YAO, Beijing (CN); Yurong CHEN, Beijing (CN); Chao LI, Beijing (CN)

(21) Appl. No.: 18/565,967

(22) PCT Filed: Nov. 30, 2021
(86) PCT No.: PCT/CN2021/134283

§ 371 Date: Nov. 30, 2023

(51) Int. Cl. G06V 10/82; G06N 3/0464; G06V 20/40

(52) U.S. Cl. CPC G06V 10/82; G06N 3/0464; G06V 20/42

(57) ABSTRACT

An apparatus, method, device and medium for dynamic quadruple convolution in a 3-dimensional (3D) convolutional neural network (CNN) are provided. The method includes: a multi-dimensional attention block configured to: receive an input feature map of a video data sample; and dynamically generate convolutional kernel scalars along four dimensions of a 3-dimensional convolution kernel space based on the input feature map, the four dimensions comprising an output channel number, an input channel number, a temporal size and a spatial size; and a convolution block configured to sequentially multiply the generated convolutional kernel scalars with a static 3D convolution kernel in a matrix-vector product way to obtain a dynamic kernel of dynamic quadruple convolution.

### TECHNICAL FIELD

Embodiments of the present disclosure generally relate to techniques of convolutional neural networks (CNNs), and in particular to an apparatus and a method for dynamic quadruple convolution in a 3-dimensional (3D) CNN.

### BACKGROUND ART

3D CNNs are constructed with 3D convolutional operations which are performed naturally in the spatial-temporal space of input data. Due to the joint spatial-temporal modelling capability, 3D CNNs have become the mainstream models widely used in advanced video analysis tasks, including video action recognition and detection, video object detection and segmentation, etc.

### Summary

According to an aspect of the disclosure, an apparatus for dynamic quadruple convolution in a 3-dimensional (3D) convolutional neural network (CNN) is provided. The apparatus includes: a multi-dimensional attention block configured to receive an input feature map of a video data sample; and dynamically generate convolutional kernel scalars along four dimensions of a 3D convolution kernel space based on the input feature map, the four dimensions comprising an output channel number, an input channel number, a temporal size and a spatial size; and a convolution block configured to sequentially multiply the generated convolutional kernel scalars with a static 3D convolution kernel in a matrix-vector product way to obtain a dynamic kernel of dynamic quadruple convolution.

According to another aspect of the disclosure, a method for dynamic quadruple convolution in a 3-dimensional (3D) convolutional neural network (CNN) is provided. The method includes: receiving, by a multi-dimensional attention block, an input feature map of a video data sample; dynamically generating, by the multi-dimensional attention block, convolutional kernel scalars along four dimensions of a 3D convolution kernel space based on the input feature map, the four dimensions comprising an output channel number, an input channel number, a temporal size and a spatial size; and sequentially multiplying the generated convolutional kernel scalars with a static 3D convolution kernel in a matrix-vector product way to obtain a dynamic kernel of dynamic quadruple convolution.

Another aspect of the disclosure provides a device including means for implementing the method of the disclosure.

Another aspect of the disclosure provides a machine readable storage medium having instructions stored thereon, which when executed by a machine cause the machine to perform the method of the disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1a is a block diagram illustrating a conventional convolution layer in a 3D CNN.

FIG. 1b is a block diagram illustrating an existing dynamic convolution layer in a 3D CNN.

FIG. 1c is a block diagram illustrating a dynamic quadruple convolution (DqConv) layer in a 3D CNN in accordance with some embodiments of the disclosure.

FIG. 2 is a block diagram illustrating an exemplary Multi-dimensional Attention (MDA) block for DqConv in accordance with some embodiments of the disclosure.

FIG. 3 is an exemplary illustration of a DqConv layer with an instantiation of MDA block in accordance with some embodiments of the disclosure.

FIG. 4 illustrates visualization comparisons of activation maps for Kinetics dataset using R(2+1)D ResNet-18 as backbone, wherein each of FIGS. 4(a)-(d) shows, from up to bottom: original input video clip; baseline of R(2+1)D ResNet-18; applying the DqConv to baseline model.

FIG. 5 illustrates a flow chart of an exemplary method for DqConv in a 3D CNN in accordance with some embodiments of the disclosure.

FIG. 6 is a block diagram illustrating components, according to some example embodiments, able to read instructions from a machine-readable or computer-readable medium and perform any one or more of the methodologies discussed herein.

FIG. 7 is a block diagram of an example processor platform in accordance with some embodiments of the disclosure.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment”, “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

Currently, training high-performance 3D CNNs for video analysis is a challenging problem due to the large number of learnable parameters. To augment the capacity of 3D CNNs from the perspective of convolution operations, there exists currently two categories of solutions. The first is to decompose 3D convolutional operation into various forms of separable 2D and 1D convolutions along spatial and temporal dimensions respectively, such as P3D, S3D, FstCN, R(2+1)D and X3D, etc. This kind of solutions ease the training of 3D CNNs to some extent at the cost of joint spatiotemporal modelling capabilities. The second is to introduce extra controller to adjust or generate convolutional parameters, including dynamic convolution which applies soft attention along specific dimension on convolutional weights, kernel shape or sampling offsets adaptation, and weight prediction, etc. This kind of solutions perform adaptive inference with dynamic parameters to increase model capability, however they suffer from a linear increase of the number of the parameters in the convolutional layers, besides they are mainly proposed for image tasks and show unsatisfied performance boost when applying to relatively large networks.

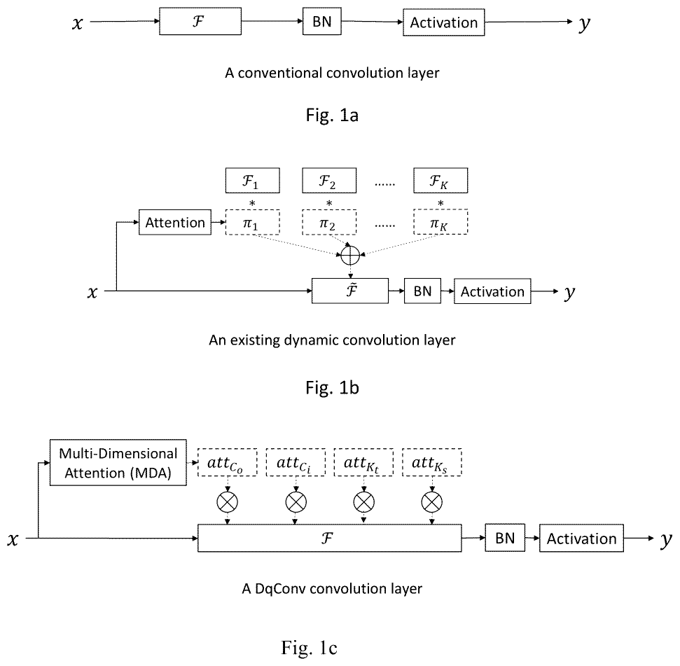

FIG. 1a illustrates a block diagram of a conventional convolution layer in a 3D CNN, FIG. 1b illustrates a block diagram of an existing dynamic convolution layer in a 3D CNN. The conventional 3D convolution as shown in Fig. la is to learn a static 3D convolutional kernel per layer and the kernel is fixed during inference. The existing dynamic convolution solution shown in FIG. 1b learns an adaptive ensemble of multiple convolutional kernels using an attention block. It suffers from a linear increase of the number of the parameters with respect to the number of convolutional kernels being ensembled.

With respect to the existing 3D Convolutions, let X∈ [symbol] ^{C}^{ᵢ}^{×T×H×W} denote the input feature map, where T, H and W represent its temporal length, spatial height and width, and Cᵢ denotes the number of input channels. Considering a conventional 3D convolutional operation with an output channel number of Cₒ and with a kernel size of Kₜ×Kₕ×K_{w} (where Kₜ represents the temporal length of the kernel, Kₕ represents the spatial height of the kernel, and K_{w} represents the spatial width of the kernel), the convolutional filters are denoted as [symbol] ∈ [symbol] ^{C}^{ₒ}×Cᵢ^{×K}^{ₜ}^{×K}^{ₕ}^{×K}^{_{w}}, where each filter [symbol] ₖ∈ [symbol] ^{c}^{ᵢ}^{×K}^{ₜ}^{×K}^{ₕ}^{×K}^{_{w}}, k=1,2, . . . , Cₒ, contains Cᵢ 3D convolution kernels [symbol] _{k,c} ∈ [symbol] ^{K}^{ₜ}^{×K}^{ₕ}^{×K}^{_{w}}, c=1,2, . . . , Cᵢ. To be simplified, the spatial kernel size Kₕ×K_{w} is denoted as Kₛ in the following parts. A conventional 3D convolution operation as shown in FIG. 1a can be written as

$$Y = X ⊗ ℱ \qquad ( 1 )$$

where the output feature map Y ∈ [symbol] ^{C}^{ₒ}^{×T×H×W}. The convolutional filters [symbol] at a convolutional layer are static, which means the filter are fixed and applied to all input samples.

Different from conventional static convolutions, existing dynamic convolutions are sample-adaptive as shown in FIG. 1b, they can be formulated as

$$Y = X ⊗ \tilde{ℱ} = X ⊗ ( {\sum }_{n = 1}^{K} {π}_{n} {ℱ}_{n} ) \qquad ( 2 )$$

where πₙ, n=1,2, . . . K is dynamically generated by an attention block to adaptively ensemble K convolutional kernels. When using these existing dynamic convolutions to replace regular (static) convolutions, it will lead to about K times memory cost for model storage where K indicates the number of dynamic kernels being used and is usually set to 4 or 8. Besides, existing dynamic convolutions apply the attention mechanism merely to one of four dimensions of the 3D convolutional kernel, limiting the capability of existing dynamic convolution designs to a large extent. Therefore, there exist substantial rooms for developing an optimal dynamic 3D convolution design.

In order to overcome the problem in training high-performance 3D CNNs for video analysis, this disclosure provides a solution from a new technical perspective: augmenting the capacity of CNNs for video analysis via re-designing fundamental 3D convolution operations.

The present disclosure provides a simple yet efficient dynamic quadruple convolution (DqConv) to augment the capacity of 3D CNNs for high performance video analysis. DqConv introduces an optimal multi-dimensional attention mechanism for modulating 3D convolutional filters to be sample-dynamic, providing a performance guarantee to capture rich context cues, and striking the best tradeoff of model size and accuracy. In an embodiment, DqConv may insert a multi-dimensional attention block into the regular convolution filters of a 3D CNN, and sequentially learns attentive convolutional filter scalars along all four dimensions (regarding the spatial kernel size, the temporal kernel size, the input channel number and the output channel number) of the filter space at every convolutional layer, strengthening the feature modeling capability of the fundamental 3D convolution operations in a fine-grained manner. In addition, being a drop-in design, DqConv can be readily plugged into any prevailing 3D CNN architectures.

FIG. 1c illustrates a block diagram of a DqConv convolution layer in a 3D CNN in accordance with some embodiments of the disclosure. As shown in FIG. 1c, the DqConv incorporates a multi-dimensional attention (MDA) block to dynamically generate attentive convolutional kernel scalars along four dimensions of the 3D convolution kernel space, the four dimensions includes an output channel number, an input channel number, a temporal size and a spatial size. In this way, the number of extra parameters introduced by the DqConv is negligible and depends on the sum of the original 3D convolution kernel sizes along all four dimensions. A comparison overview of DqConv with a conventional convolution and an existing dynamic convolution is shown in FiIGS. 1a-1c.

In an embodiment, the DqConv may insert the MDA block into the original static convolutional kernels [symbol] . This MDA block dynamically generates attentive convolutional kernel scalars along all four dimensions of the 3D convolution kernel space, resulting in att_{c}_{ₒ} ∈ [symbol] ^{C}^{ₒ}^{×1×1×1}, att_{c}_{ᵢ} 531 [symbol] ^{1×C}^{ᵢ}^{1×1}, att_{K}_{^{t}} ∈ [symbol] ^{1×1×K}^{ₜ}^{×1} and att_{K}_{_{S}} ∈ [symbol] ^{1×1×1K}^{ₛ}, which represent the attentive convolutional kernel scalars along the number of output channels and input channels, temporal and spatial dimensions of convolutional kernel ( [symbol] ∈ [symbol] ^{C}^{ₒ}^{×C}^{ᵢ}^{×K}^{ₜ}^{×K}^{ₛ}). Then the DqConv as shown in FIG. 1c can be formulated as

$$Y = X ⊗ ( ℱ \times at {t}_{{C}_{o}} \times a t {t}_{{C}_{i}} \times {att}_{{K}_{t}} \times a t {t}_{{K}_{s}} ) \qquad ( 3 )$$

where “×” denotes matrix-vector product operation. Specifically, [symbol] ×att_{c}_{ₒ} illustrates each [symbol] ₖ multiplying with att_{c}_{ₒ}_{,k}, k=1,2, . . . , Cₒ, wherein att_{c}_{ₒ}_{,k} denotes the k^{th} element of the scalar att_{c}_{ₒ}. Through sequentially multiplying with four attentive scalars along different dimensions, the capability of 3D convolution kernel for modeling video/high-dimensional data features is augmented with flexible adaptiveness. Further, att_{c}_{ₒ}, att_{c}_{ₒ}, att_{K}_{ₜ} and at_{K}_{ₛ} are generated by the MDA block in an efficient way:

$$[ {att}_{{C}_{o}} , {att}_{{C}_{i}} , {att}_{{K}_{t}} , {att}_{{K}_{s}} ] = M D A ( X ) \qquad ( 4 )$$

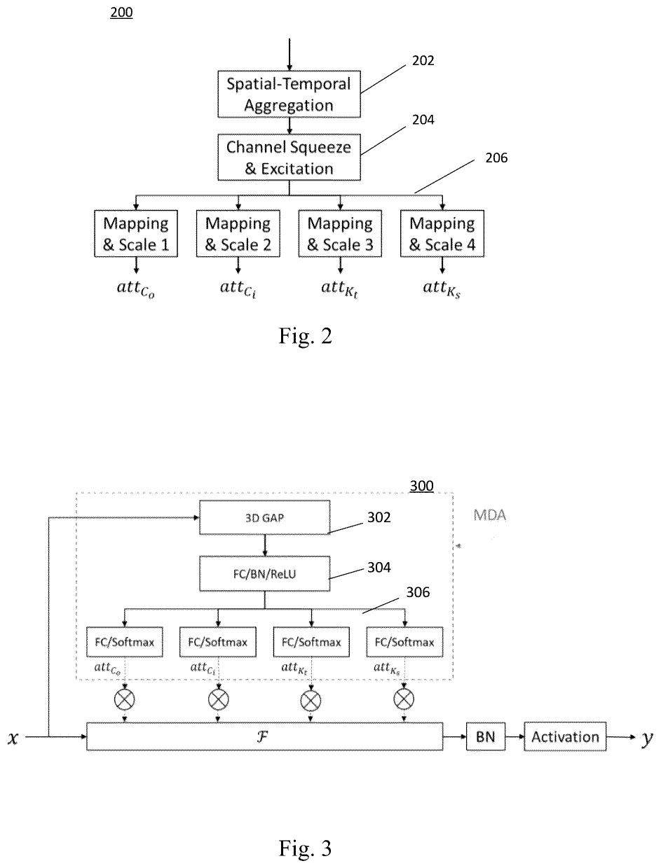

FIG. 2 illustrates an exemplary MDA block 200 for DqConv in accordance with some embodiments of the disclosure. The exemplary MDA block 200 is a lightweight structure designed for computing attentive kernel scalars along four dimensions of 3D convolution kernel space. The exemplary MDA block 200 may first aggregate the input feature maps across spatial and temporal dimensions to produce a channel descriptor. This descriptor well embeds the global distribution of channel-wise feature responses. A channel squeeze and excitation operation is followed to transform the channel descriptor for further abstraction. Next, the abstracted descriptor may be mapped and scaled to the sizes of different dimensions of 3D convolution kernel space, so as to achieve four corresponding attentive kernel scalars respectively. As denoted in Eq. (3), these scalars are then sequentially multiplied with the originally static 3D convolution kernels in a matrix-vector product way to obtain the dynamic kernel of the DqConv. This MDA block can be embedded in each convolutional layer, enabling easy end-to-end training.

Specifically, as shown in FIG. 2, the MDA block 200 may include a spatial-temporal aggregation unit 202 to perform a spatial-temporal aggregation operation on received input feature maps to produce a channel descriptor. The MDA structure may further include a channel squeeze and excitation unit 204 to perform a channel squeeze and excitation operation to transform the channel descriptor generated in the spatial-temporal aggregation unit 202 for further abstraction. In addition, the MDA block 200 may include a mapping and scaling unit 206 to perform a mapping and scaling operation to map and scale the abstracted descriptor to the sizes of different dimensions of the 3D convolution kernel space and output four corresponding attentive kernel scalars respectively.

In an embodiment, the spatial-temporal aggregation operation may be performed with 3D global average pooling (GAP). In another embodiment, the spatial-temporal aggregation may be performed with Max Pooling, Random Pooling, Min Pooling, etc., which is not limited herein.

In an embodiment, the channel squeeze and excitation operation may be performed by adopting fully connected (FC) layer with channel squeeze ratio r followed by normalization (BN) and non-linear activation (ReLU). In another embodiment, 1x1 convolution can be used to replace the FC.

In an embodiment, the mapping and scaling unit 206 may include a first mapping and scaling unit to map and scale the abstracted descriptor to the size of the dimension of output channel number Cₒ, and output the attentive kernel scalar att_{co}; a second mapping and scaling unit to map and scale the abstracted descriptor to the size of the dimension of input channel number Cᵢ, and output the attentive kernel scalar att_{ci}; a third mapping and scaling unit to map and scale the abstracted descriptor to the size of the dimension of temporal size Kₜ, and output the attentive kernel scalar attxt; and a fourth mapping and scaling unit to map and scale the abstracted descriptor to the size of the dimension of spatial size Kₛ, and output the attentive kernel scalar attks.

In an embodiment, the abstracted descriptor generated in the channel squeeze and excitation unit 204 may be mapped and scaled to be attentive scalars respectively using, for example, FC and Softmax operations. In another embodiment, 1×1 convolution operation may be used to replace the FC operation. In yet another embodiment, Sigmoid or Tanh operation may be used to replace the Softmax operation. Which is not limited herein.

In an embodiment, the DqConv may learn attentive convolutional kernel scalars along four dimensions of the kernel space at every convolutional layer through the MDA block. After being sequentially multiplied with these four attentive kernel scalars, a static 3D convolutional kernel becomes dynamically conditioned on each input example and specialized for each dimensions of kernel space. Replacing conventional 3D convolutions with DqConv enables us to increase the capacity of a 3D CNN, while maintaining efficient inference. In addition, being a drop-in design, DqConv can be readily plugged into any prevailing 3D CNN architectures such as C3D, i3D, P3D, R(2+1)D, ResNet-3D, SlowFast, etc., and boost the performance for high-performance video analysis tasks, as illustrated in example experiments described below.

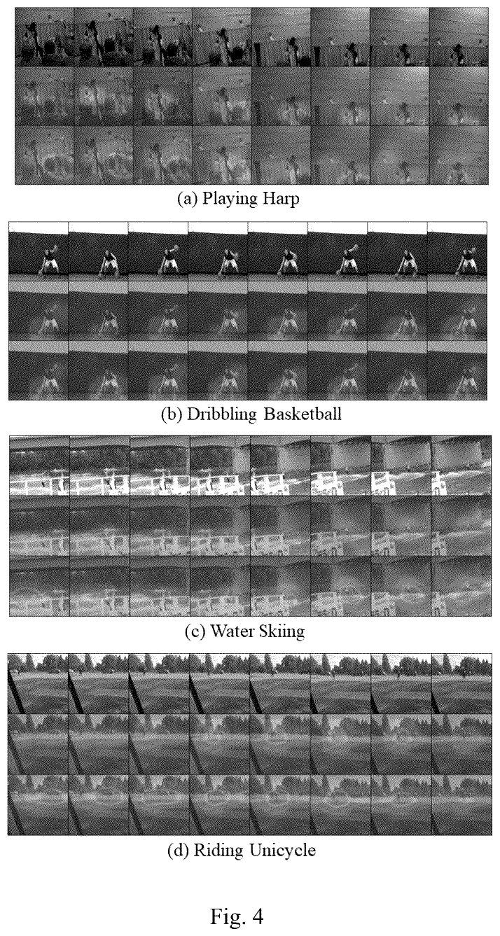

FIG. 3 illustrates an example illustration of the DqConv layer with an instantiation of MDA block in accordance with some embodiments of the disclosure. Considering the efficiency of DqConv, an instantiation of DqConv as shown in FIG. 3 may be used as example use case. Specifically, spatial-temporal aggregation of input feature maps may conducted using, for example, a 3D global average pooling (GAP) to produce a channel descriptor. A fully connected (FC) layer with channel squeeze ratio r followed by normalization (BN) and non-linear activation (ReLU) may be adopted to transform the channel descriptor for further abstraction. The abstracted descriptor is further mapped and scaled to be the attentive scalars respectively using, for example, FC and Softmax operations. In this case, the extra parameters of DqConv can be denoted as Cᵢ× Cᵢ/r+ Cᵢ/r×(Cₒ+Cᵢ+Kₜ+Kₛ). As an example, when using squeeze ratio r=4 and taking Cᵢ=Cₒ=256, the number of extra parameters introduced by DqConv is about 2.8% of the original 3D convolution kernel (Cₒ×Cᵢ×Kₜ×Kₛ), which is quite a lightweight design.

When applying the DqConv to R(2+1)D ResNet-34 and using 8-frame input with spatial size 224×224, the extra FLOPs introduced by the DqConv is 2.65 G which is around 5% of the baseline model. In addition, the DqConv brings a Top-1 performance boost of 4.05% with 1.8% total extra parameters to the baseline model (As shown in Table 1), which outperforms the previous solutions on both accuracies and efficiencies.

In an experiment, the DqConv is applied to prevailing 3D CNN backbones using video action recognition benchmarks for evaluation. Kinetics-200 is a large-scale video action recognition dataset. There are 80K training videos and 5K validation videos in total. Video frames are extracted and resized to 340×256 pixels and cropped to 224×224 when training. 32-frame clip with sampling interval of 2 may be used as network input by default, otherwise will be illustrated in the settings.

TABLE 1
Performance comparison of the DqConv, CondConv
and DyConv on Kinetics-200 dataset.

| Method | #Param. | Input Size | Top-1 Acc (%) | Top-5 Acc (%) |
|---|---|---|---|---|
| R(2+1)D-R34 | 63.76M | 8 × 3 × 224 × 224 | 71.77 | 91.19 |
| +CondConv | 503.62M | | 72.86 | 91.84 |
| +DyConv | 245.04M | | 73.62 | 92.06 |
| +DqConv | 64.92M | | 75.62 | 93.25 |
| R(2+1)D-R18 | 33.43M | 32 × 3 × 224 × 224 | 76.18 | 93.55 |
| +CondConv | 265.09M | | 76.86 | 93.78 |
| +DyConv | 133.21M | | 77.26 | 93.95 |
| +DqConv | 34.05M | | 80.23 | 94.83 |

Table 1 shows a comprehensive comparison of DqConv with previous state-of-the-art solutions (CondConv (Conditionally parameterized convolutions) and Dyconv (Dynamic convolution: Attention over convolution kernels) on Kinetics-200 dataset. Specifically, DqConv is applied to R(2+1)D using ResNet-34 and ResNet-18 as backbones. For R(2+1)D R34, 8-frame input with a spatial resolution of 224×224 is used. As shown, DqConv outperforms baseline with less extra parameters but larger performance boost compared with CondConv and DyConv. For R(2+1)D R18, a 32-frame input is used to further model longer-term motion dynamics. As shown, DqConv achieves consistent and significant performance advantages over previous solutions, which demonstrates the effectiveness and efficiency of DqConv for high performance video analysis.

Table 2 shows the performance comparison of DqConv on Kinetics-200 dataset when being applied to different prevailing 3D CNN backbones, including R(2+1)D, R3D and SlowFast. As shown, DqConv brings consistent and significant accuracy improvements to all baseline models with negligible extra parameters, yielding over 3% top-1 margins. Besides, the smaller the original model size, the larger the accuracy gain, showing great potential in deploying high-performance video analysis models on edge/cloud clients.

TABLE 2
Performance comparison on Kinetics-200 dataset when applying
DqConv to different kinds of prevailing 3D CNN backbones.

| Method | Backbone | Top-1 (%) | Δ Top-1(%) |
|---|---|---|---|
| Baseline | R(2+1)D-ResNet-18 | 76.18 | +4.05 |
| DqConv | | 80.23 | |
| Baseline | R(2+1)D-ResNet-34 | 71.77 | +3.85 |
| DqConv | | 75.62 | |
| Baseline | ResNet-3D-50 | 76.68 | +3.28 |
| DqConv | | 79.96 | |
| Baseline | SlowFast-ResNet- | 77.15 | +3.17 |
| DqConv | 50 | 80.32 | |

Table 3 shows the performance comparison of DqConv on a much larger benchmark, Kinetics-400 dataset. It contains video samples more than double of Kinetics-200. As shown, the improvements of DqConv on Kinetics-400 are larger (over 4.5% top-1 margin) than that on Kinetics-200, showing its good generalization ability to larger-scale and challenging video datasets.

TABLE 3
Performance comparison on Kinetics-400 dataset.

| Method | Backbone | Top-1 (%) | Δ Top-1(%) |
|---|---|---|---|
| Baseline | R(2+1)D-ResNet-18 | 74.28 | +4.81 |
| DqConv | | 79.09 | |

As can be seen, DqConv significantly improved accuracy for 3D CNN models with efficient design. When applied the DqConv to different prevailing 3D CNNs on large-scale video action recognition datasets, including Kinetics-200/400, showing that DqConv brings promising accuracy improvements to various backbone models and leads to significantly smaller increases in the model complexity compared with previous counterparts.

FIG. 4 illustrates visualization comparisons of activation maps for Kinetics dataset using R(2+1)D ResNet-18 as backbone, wherein each of (a)-(d) in Fig.4 shows, from up to bottom: original input video clip; baseline of R(2+1)D ResNet-18; applying the DqConv to baseline model. As shown in Fig.4, the DqConv tends to learn video features consistently and accurately localizing motion related attentional regions in different action examples, augmenting the capacity of 3D CNNs in modeling rich spatial-temporal context cues.

As shown in FIG. 4, replacing the original convolutions with the DqConv improves the spatial-temporal feature learning significantly. It tends to consistently emphasize motion related attentional regions within a video clip, demonstrating its efficiency in modeling rich complex spatiotemporal cues for 3D CNNs.

In addition to large scale video recognition task, in an embodiment, the DqConv may also applied to other challenging tasks, including transfer learning. As can be seen in Table 4, which shows performance of DqConv when being transferred to UCF-101 dataset, models with the DqConv also achieves a significant performance boost when transferring to UCF-101 dataset.

TABLE 4
Performance of DqConv when being
transferred to UCF-101 dataset.

| Method | Backbone | Top-1 (%) | Δ Top-1(%) |
|---|---|---|---|
| Baseline | R(2+1)D-ResNet-18 | 84.03 | +5.26 |
| DqConv | | 89.29 | |

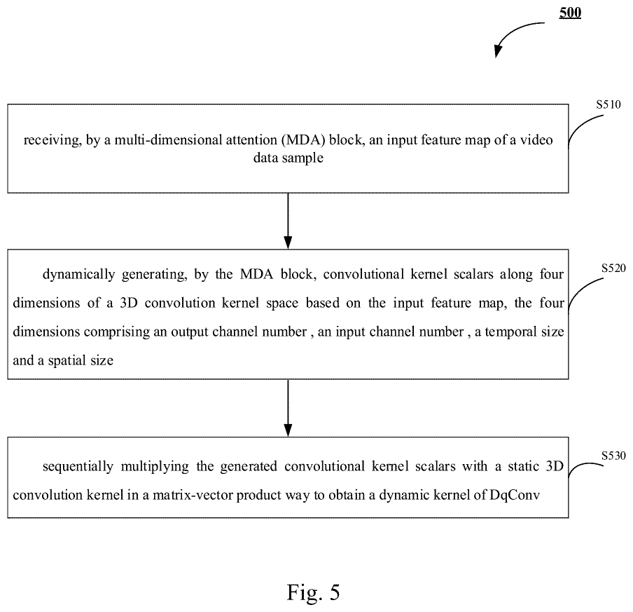

FIG. 5 illustrates a flow chart illustrating an exemplary method 500 for DqConv in a 3D CNN in accordance with some embodiments of the disclosure. The method 500 may include blocks S510-S530.

At block S510, an input feature map of a video data sample may be received, for example, by the MDA block 200 in FIG. 2 or the MDA block 300 in FIG. 3. At block S520, convolutional kernel scalars along four dimensions of 3D convolution kernel space may be dynamically generated based on the input feature map, for example, by the MDA block 200 in FIG. 2 or the MDA block 300 in FIG. 3, wherein the four dimensions includes an output channel number, an input channel number, a temporal size and a spatial size. At block S530, the generated convolutional kernel scalars may be sequentially multiplied with a static 3D convolution kernel in a matrix-vector product way to obtain a dynamic kernel of DqConv.

In some embodiments, the method 500 may include more or less steps. The disclosure is not limited in this aspect. Also, the method 500 may be understood in conjunction with the embodiments described above.

The present disclosure provides a simple yet efficient DqConv to augment the capacity of 3D CNNs for high performance video analysis. Being a drop-in design, DqConv can be readily plugged into any prevailing 3D CNN architectures and boost the performance for high-performance video analysis tasks. DqConv introduces an optimal multi-dimensional attention mechanism for modulating 3D convolutional filters to be sample-dynamic, providing a performance guarantee to capture rich context cues, and striking the best tradeoff of model size and accuracy. DqConv can also enhancing existing solutions to Artificial Intelligence (AI)/deep Learning (DL)/Machine Learning (ML) related hardware (HW) designing, SW (software) development and high-performance advanced video analysis applications, including video action recognition and detection, video object detection and segmentation, etc.

As an indispensable component of deep CNNs, the present disclosure shows great generalization in advanced video analysis tasks (action recognition, transfer learning, etc.) and helps in providing software stack for deployment of deep 3D models on edge/cloud devices and high-performance distributed/parallel computing systems. DqConv technique may be implemented on, e.g., Intel GPU Compute Architecture and may be adopted as one of the business features for the Large Compute Cluster design and business.

In addition, being a plug-and-play design, DqConv can be applied to any existing 3D CNNs, largely augmenting the capacity of 3D models.

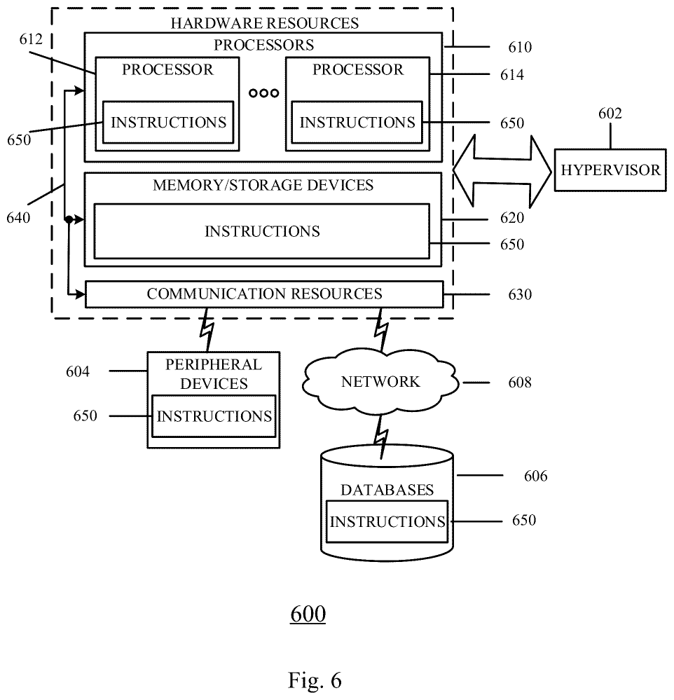

FIG. 6 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 6 shows a diagrammatic representation of hardware resources 600 including one or more processors (or processor cores) 610, one or more memory/storage devices 620, and one or more communication resources 630, each of which may be communicatively coupled via a bus 640. For embodiments where node virtualization (e.g., NFV) is utilized, a hypervisor 602 may be executed to provide an execution environment for one or more network slices/sub-slices to utilize the hardware resources 600.

The processors 610 may include, for example, a processor 612 and a processor 614 which may be, e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof.

The memory/storage devices 620 may include main memory, disk storage, or any suitable combination thereof. The memory/storage devices 620 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 630 may include interconnection or network interface components or other suitable devices to communicate with one or more peripheral devices 604 or one or more databases 606 via a network 608. For example, the communication resources 630 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

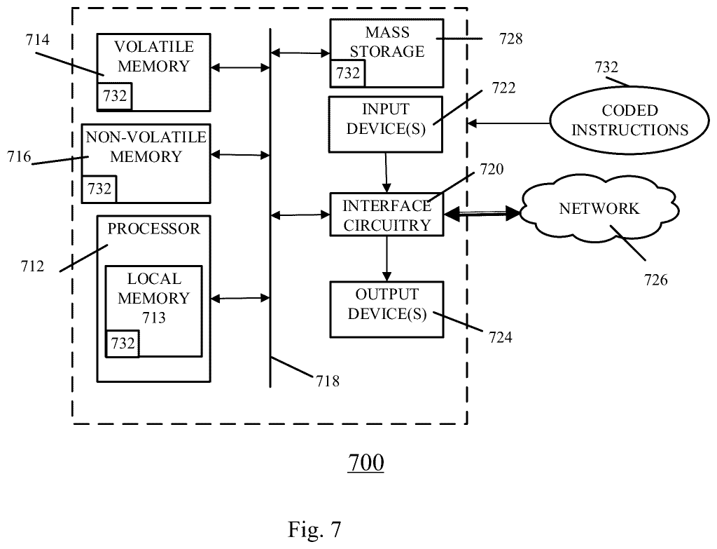

FIG. 7 is a block diagram of an example processor platform in accordance with some embodiments of the disclosure. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes interface circuitry 720. The interface circuitry 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuitry 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 720 of the illustrated example, thus, typically includes a graphics driver card, a graphics driver chip and/or a graphics driver processor.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 720 may include a training dataset inputted through the input device(s) 722 or retrieved from the network 726.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

Machine executable instructions 732 may be stored in the mass storage device 728, in the volatile memory 714, in the non-volatile memory 716, and/or on a removable non-transitory computer readable storage medium such as a CD or DVD.

The following paragraphs describe examples of various embodiments.

Example 1 includes an apparatus for dynamic quadruple convolution in a 3-dimensional (3D) convolutional neural network (3D CNN), comprising: a multi-dimensional attention block configured to: receive an input feature map of a video data sample; and dynamically generate convolutional kernel scalars along four dimensions of a 3D convolution kernel space based on the input feature map, the four dimensions comprising an output channel number, an input channel number, a temporal size and a spatial size; and a convolution block configured to sequentially multiply the generated convolutional kernel scalars with a static 3D convolution kernel in a matrix-vector product way to obtain a dynamic kernel of dynamic quadruple convolution.

Example 2 includes the apparatus of Example 1, wherein the multi-dimensional attention block comprising: a spatial-temporal aggregation unit to perform a spatial-temporal aggregation operation on the input feature map to produce a channel descriptor; a channel squeeze and excitation unit to perform a channel squeeze and excitation operation to transform the channel descriptor for further abstraction; and a mapping and scaling unit to perform a mapping and scaling operation to map and scale the abstracted descriptor to the sizes of different dimensions of the 3D convolution kernel space and output four corresponding attentive kernel scalars respectively.

Example 3 includes the apparatus of Example 1 or 2, wherein the spatial-temporal aggregation operation is performed with at least one of 3D Global Average Pooling, Max Pooling, Random Pooling or Min Pooling.

Example 4 includes the apparatus of any of Examples 1-3, wherein the channel squeeze and excitation operation is performed by adopting a fully connected or 1×1 convolution layer with channel squeeze ratio r followed by normalization and non-linear activation.

Example 5 includes the apparatus of any of Examples 1-4, wherein the mapping and scaling operation is performed using an operation of fully connected or 1x1 convolution layer, and an operation of Softmax, Sigmoid or Tanh.

Example 6 includes the apparatus of any of Examples 1-5, wherein the mapping and scaling unit comprising: a first mapping and scaling unit to map and scale the abstracted descriptor to the size of the dimension of output channel number, and output the attentive kernel scalar along the dimension of output channel number; a second mapping and scaling unit to map and scale the abstracted descriptor to the size of the dimension of input channel number, and output the attentive kernel scalar along the dimension of input channel number; a third mapping and scaling unit to map and scale the abstracted descriptor to the size of the dimension of temporal size, and output the attentive kernel scalar along the dimension of temporal size; and a fourth mapping and scaling unit to map and scale the abstracted descriptor to the size of the dimension of spatial size, and output the attentive kernel scalar along the dimension of spatial size.

Example 7 includes the apparatus of any of Examples 1-6, wherein the multi-dimensional attention block is embedded in each convolutional layer of the 3D CNN.

Example 8 includes the apparatus of any of Examples 1-7, wherein the dynamic quadruple convolution is applied to any type of 3D CNN.

Example 9 includes the apparatus of any of Examples 1-8, wherein the dynamic quadruple convolution is performed for advanced video analysis tasks.

Example 10 includes the apparatus of any of Examples 1-9, wherein the dynamic quadruple convolution is performed for transfer learning.

Example 11 includes the apparatus of any of Examples 1-10, wherein the dynamic quadruple convolution is performed for action recognition.

Example 12 includes a method for dynamic quadruple convolution in a 3-dimensional (3D) convolutional neural network (CNN), comprising: receiving, by a multi-dimensional attention block, an input feature map of a video data sample; dynamically generating, by the multi-dimensional attention block, convolutional kernel scalars along four dimensions of a 3D convolution kernel space based on the input feature map, the four dimensions comprising output channel number, input channel number, temporal size and spatial size; and sequentially multiplying the generated convolutional kernel scalars with a static 3D convolution kernel in a matrix-vector product way to obtain a dynamic kernel of dynamic quadruple convolution.

Example 13 includes the method of Example 12, further comprising: performing a spatial-temporal aggregation operation on the input feature map to produce a channel descriptor; performing a channel squeeze and excitation operation to transform the channel descriptor for further abstraction; and performing a mapping and scaling operation to map and scale the abstracted descriptor to the sizes of different dimensions of the 3D convolution kernel space and output four corresponding attentive kernel scalars respectively.

Example 14 includes the method of Example 12 or 13, wherein the spatial-temporal aggregation operation is performed with at least one of 3D Global Average Pooling, Max Pooling, Random Pooling or Min Pooling.

Example 15 includes the method of any of Examples 12-14, wherein the channel squeeze and excitation operation is performed by adopting a fully connected or 1x1 convolution layer with channel squeeze ratio r followed by normalization and non-linear activation.

Example 16 includes the method of any of Examples 12-15, wherein the mapping and scaling operation is performed using an operation of fully connected or 1x1 convolution layer, and an operation of Softmax, Sigmoid or Tanh.

Example 17 includes the method of any of Examples 12-16, wherein the mapping and scaling operation comprising: mapping and scaling, by a first mapping and scaling unit, the abstracted descriptor to the size of the dimension of output channel number, and outputting the attentive kernel scalar along the dimension of output channel number; mapping and scaling, by a second mapping and scaling unit, the abstracted descriptor to the size of the dimension of input channel number, and outputting the attentive kernel scalar along the dimension of input channel number; mapping and scaling, by a third mapping and scaling unit, the abstracted descriptor to the size of the dimension of temporal size, and outputting the attentive kernel scalar along the dimension of temporal size; and mapping and scaling, by a fourth mapping and scaling unit, the abstracted descriptor to the size of the dimension of spatial size, and outputting the attentive kernel scalar along the dimension of spatial size.

Example 18 includes the method of any of Examples 12-17, wherein the multi-dimensional attention block is embedded in each convolutional layer of the 3D CNN.

Example 19 includes the method of any of Examples 12-18, wherein the dynamic quadruple convolution is applied to any type of 3D CNN.

Example 20 includes the method of any of Examples 12-19, wherein the dynamic quadruple convolution is performed for advanced video analysis tasks.

Example 21 includes the method of any of Examples 12-20, wherein the dynamic quadruple convolution is performed for transfer learning.

Example 22 includes the method of any of Examples 12-21, wherein the dynamic quadruple convolution is performed for action recognition.

Example 23 includes a machine readable storage medium, having instructions stored thereon, which when executed by a machine, cause the machine to perform a method for dynamic quadruple convolution in a 3-dimensional (3D) convolutional neural network (CNN), the method comprising: receiving, by a multi-dimensional attention block, an input feature map of a video data sample; dynamically generating, by the multi-dimensional attention block, convolutional kernel scalars along four dimensions of a 3D convolution kernel space based on the input feature map, the four dimensions comprising an output channel number, an input channel number, a temporal size and a spatial size; and sequentially multiplying the generated convolutional kernel scalars with a static 3D convolution kernel in a matrix-vector product way to obtain a dynamic kernel of dynamic quadruple convolution.

Example 24 includes the machine readable storage medium of Example 23, wherein the instructions when executed by the machine further cause the machine to: perform a spatial-temporal aggregation operation on the input feature map to produce a channel descriptor; perform a channel squeeze and excitation operation to transform the channel descriptor for further abstraction; and perform a mapping and scaling operation to map and scale the abstracted descriptor to the sizes of different dimensions of the 3D convolution kernel space and output four corresponding attentive kernel scalars respectively.

Example 25 includes the machine readable storage medium of Example 23 or 24, wherein the spatial-temporal aggregation operation is performed with at least one of 3D Global Average Pooling, Max Pooling, Random Pooling or Min Pooling.

Example 26 includes the machine readable storage medium of any of Examples 23-25, wherein the channel squeeze and excitation operation is performed by adopting a fully connected or 1×1 convolution layer with channel squeeze ratio r followed by normalization and non-linear activation.

Example 27 includes the machine readable storage medium of any of Examples 23-26, wherein the mapping and scaling operation is performed using an operation of fully connected or 1×1 convolution layer, and an operation of Softmax, Sigmoid or Tanh.

Example 28 includes the machine readable storage medium of any of Examples 23-27, wherein the mapping and scaling operation comprising: mapping and scaling, by a first mapping and scaling unit, the abstracted descriptor to the size of the dimension of output channel number, and outputting the attentive kernel scalar along the dimension of output channel number; mapping and scaling, by a second mapping and scaling unit, the abstracted descriptor to the size of the dimension of input channel number, and outputting the attentive kernel scalar along the dimension of input channel number; mapping and scaling, by a third mapping and scaling unit, the abstracted descriptor to the size of the dimension of temporal size, and outputting the attentive kernel scalar along the dimension of temporal size; and mapping and scaling, by a fourth mapping and scaling unit, the abstracted descriptor to the size of the dimension of spatial size, and outputting the attentive kernel scalar along the dimension of spatial size.

Example 29 includes the machine readable storage medium of any of Examples 23-28, wherein the multi-dimensional attention block is embedded in each convolutional layer of the 3D CNN.

Example 30 includes the machine readable storage medium of any of Examples 23-29, wherein the dynamic quadruple convolution is applied to any type of 3D CNN.

Example 31 includes the machine readable storage medium of any of Examples 23-30, wherein the dynamic quadruple convolution is performed for advanced video analysis tasks.

Example 32 includes the machine readable storage medium of any of Examples 23-31, wherein the dynamic quadruple convolution is performed for transfer learning.

Example 33 includes the machine readable storage medium of any of Examples 23-32, wherein the dynamic quadruple convolution is performed for action recognition.

Example 34 includes a device for dynamic quadruple convolution in a 3-dimensional convolutional neural network (3D CNN), comprising: means for receiving an input feature map of a video data sample; means for dynamically generating convolutional kernel scalars along four dimensions of a 3D convolution kernel space based on the input feature map, the four dimensions comprising an output channel number, an input channel number, a temporal size and a spatial size; and means for sequentially multiplying the generated convolutional kernel scalars with a static 3D convolution kernel in a matrix-vector product way to obtain a dynamic kernel of dynamic quadruple convolution.

Example 35 includes the device of Example 34, further comprising: means for performing a spatial-temporal aggregation operation on the input feature map to produce a channel descriptor; means for performing a channel squeeze and excitation operation to transform the channel descriptor for further abstraction; and means for performing a mapping and scaling operation to map and scale the abstracted descriptor to the sizes of different dimensions of the 3D convolution kernel space and output four corresponding attentive kernel scalars respectively.

Example 36 includes the device of Example 34 or 35, wherein the spatial-temporal aggregation operation is performed with at least one of 3D Global Average Pooling, Max Pooling, Random Pooling or Min Pooling.

Example 37 includes the device of any of Examples 34-36, wherein the channel squeeze and excitation operation is performed by adopting a fully connected or 1x1 convolution layer with channel squeeze ratio r followed by normalization and non-linear activation.

Example 38 includes the device of any of Examples 34-37, wherein the mapping and scaling operation is performed using an operation of fully connected or 1x1 convolution layer, and an operation of Softmax, Sigmoid or Tanh.

Example39 includes the device of any of Examples 34-38, further comprising: means for mapping and scaling the abstracted descriptor to the size of the dimension of output channel number, and outputting the attentive kernel scalar along the dimension of output channel number; means for mapping and scaling the abstracted descriptor to the size of the dimension of input channel number, and outputting the attentive kernel scalar along the dimension of input channel number; means for mapping and scaling the abstracted descriptor to the size of the dimension of temporal size, and outputting the attentive kernel scalar along the dimension of temporal size; and means for mapping and scaling the abstracted descriptor to the size of the dimension of spatial size, and outputting the attentive kernel scalar along the dimension of spatial size.

Example 40 includes the device of any of Examples 34-39, wherein the device is embedded in each convolutional layer of the 3D CNN.

Example 41 includes the device of any of Examples 34-40, wherein the dynamic quadruple convolution is applied to any type of 3D CNN.

Example 42 includes the device of any of Examples 34-41, wherein the dynamic quadruple convolution is performed for advanced video analysis tasks.

Example 43 includes the device of any of Examples 34-42, wherein the dynamic quadruple convolution is performed for transfer learning.

Example 44 includes the device of any of Examples 34-43, wherein the dynamic quadruple convolution is performed for action recognition.

Example 45 includes an apparatus as shown and described in the description.

Example 46 includes a method performed at an apparatus as shown and described in the description.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. The disclosure is intended to cover any adaptations or variations of the embodiments discussed herein. Therefore, it is manifestly intended that embodiments described herein be limited only by the appended claims and the equivalents thereof.

1. An apparatus for dynamic quadruple convolution in a 3-dimensional (3D) convolutional neural network (CNN), comprising:
a multi-dimensional attention block configured to:
receive an input feature map of a video data sample; and
dynamically generate convolutional kernel scalars along four dimensions of a 3-dimensional convolution kernel space based on the input feature map, the four dimensions comprising an output channel number, an input channel number, a temporal size and a spatial size; and
a convolution block configured to sequentially multiply the generated convolutional kernel scalars with a static 3-dimensional convolution kernel in a matrix-vector product way to obtain a dynamic kernel of dynamic quadruple convolution.

2. The apparatus of claim 1, wherein the multi-dimensional attention block comprises:
a spatial-temporal aggregation unit to perform a spatial-temporal aggregation operation on the input feature map to produce a channel descriptor;
a channel squeeze and excitation unit to perform a channel squeeze and excitation operation to transform the channel descriptor for further abstraction; and
a mapping and scaling unit to perform a mapping and scaling operation to map and scale the abstracted descriptor to the sizes of different dimensions of the 3-dimensional convolution kernel space and output the four corresponding attentive kernel scalars respectively.

3. The apparatus of claim 2, wherein the spatial-temporal aggregation operation is performed with at least one of 3-dimensional Global Average Pooling, Max Pooling, Random Pooling or Min Pooling.

4. The apparatus of claim 2, wherein the channel squeeze and excitation operation is performed by adopting a fully connected or 1×1 convolution layer with channel squeeze ratio r followed by normalization and non-linear activation.

5. The apparatus of claim 2, wherein the mapping and scaling operation is performed using an operation of fully connected or 1×1 convolution layer, and an operation of Softmax, Sigmoid or Tanh.

6. The apparatus of claim 5, wherein the mapping and scaling unit comprises:
a first mapping and scaling unit to map and scale the abstracted descriptor to the size of the dimension of output channel number, and output the attentive kernel scalar along the dimension of output channel number;
a second mapping and scaling unit to map and scale the abstracted descriptor to the size of the dimension of input channel number, and output the attentive kernel scalar along the dimension of input channel number;
a third mapping and scaling unit to map and scale the abstracted descriptor to the size of the dimension of temporal size, and output the attentive kernel scalar along the dimension of temporal size; and
a fourth mapping and scaling unit to map and scale the abstracted descriptor to the size of the dimension of spatial size, and output the attentive kernel scalar along the dimension of spatial size.

7. The apparatus of claim 1, wherein the multi-dimensional attention block is embedded in each convolutional layer of the 3D CNN.

8. The apparatus of claim 1, wherein the dynamic quadruple convolution is applied to any type of 3D CNN.

9. The apparatus of claim 1, wherein the dynamic quadruple convolution is performed for at least one of advanced video analysis tasks, transfer learning or action recognition.

10. (canceled)

11. (canceled)

12. A method for dynamic quadruple convolution in a 3-dimensional (3D) convolutional neural network (CNN), comprising:
receiving, by a multi-dimensional attention block, an input feature map of a video data sample;
dynamically generating, by the multi-dimensional attention block, convolutional kernel scalars along four dimensions of a 3-dimensional convolution kernel space based on the input feature map, the four dimensions comprising an output channel number, an input channel number, a temporal size and a spatial size; and
sequentially multiplying the generated convolutional kernel scalars with a static 3-dimensional convolution kernel in a matrix-vector product way to obtain a dynamic kernel of dynamic quadruple convolution.

13. The method of claim 12, further comprising:
performing a spatial-temporal aggregation operation on the input feature map to produce a channel descriptor;
performing a channel squeeze and excitation operation to transform the channel descriptor for further abstraction; and
performing a mapping and scaling operation to map and scale the abstracted descriptor to the sizes of different dimensions of the 3-dimensional convolution kernel space and output the four corresponding attentive kernel scalars respectively.

14. The method of claim 13, wherein the spatial-temporal aggregation operation is performed with at least one of 3-dimensional Global Average Pooling, Max Pooling, Random Pooling or Min Pooling.

15. The method of claim 13, wherein the channel squeeze and excitation operation is performed by adopting a fully connected or 1×1 convolution layer with channel squeeze ratio r followed by normalization and non-linear activation.

16. The method of claim 13, wherein the mapping and scaling operation is performed using an operation of fully connected or 1×1 convolution layer, and an operation of Softmax, Sigmoid or Tanh.

17. The method of claim 16, wherein the mapping and scaling operation comprising:
mapping and scaling, by a first mapping and scaling unit, the abstracted descriptor to the size of the dimension of output channel number, and outputting the attentive kernel scalar along the dimension of output channel number;
mapping and scaling, by a second mapping and scaling unit, the abstracted descriptor to the size of the dimension of input channel number, and outputting the attentive kernel scalar along the dimension of input channel number;
mapping and scaling, by a third mapping and scaling unit, the abstracted descriptor to the size of the dimension of temporal size, and outputting the attentive kernel scalar along the dimension of temporal size; and
mapping and scaling, by a fourth mapping and scaling unit, the abstracted descriptor to the size of the dimension of spatial size, and outputting the attentive kernel scalar along the dimension of spatial size.

18. The method of claim 12, wherein the multi-dimensional attention block is embedded in each convolutional layer of the 3D CNN.

19. (canceled)

20. The method of claim 12, wherein the dynamic quadruple convolution is performed for advanced video analysis tasks.

21. The method of claim 20, wherein the dynamic quadruple convolution is performed for action recognition or transfer learning.

22. A machine readable storage medium comprising instructions which when executed by a machine, cause the machine to:
access an input feature map of a video data sample;
dynamically generate convolutional kernel scalars along four dimensions of a 3-dimensional convolution kernel space based on the input feature map, the four dimensions including an output channel number, an input channel number, a temporal size and a spatial size; and
sequentially multiply the generated convolutional kernel scalars with a static 3-dimensional convolution kernel in a matrix-vector product way to obtain a dynamic kernel of dynamic quadruple convolution.

23. The machine readable storage medium of claim 22, wherein the instructions when executed by the machine further cause the machine to:
perform a spatial-temporal aggregation operation on the input feature map to produce a channel descriptor;
perform a channel squeeze and excitation operation to transform the channel descriptor for further abstraction; and
perform a mapping and scaling operation to map and scale the abstracted descriptor to the sizes of different dimensions of the 3-dimensional convolution kernel space and output the four corresponding attentive kernel scalars respectively.

24. (canceled)
